(19) United States
(12) Patent Application Publication
(10) Pub. No.: US 2005/0073479 A1
(43) Pub. Date: Apr. 7, 2005

(54) Display apparatus and method for driving display panel

(75) Inventors: Hikaru Takahashi, Nakakoma-gun (JP); Hideto Endo, Nakakoma-gun (JP); Keishi Saito, Nakakoma-gun (JP); Kazuo Yahagi, Nakakoma-gun (JP); Yuya Shiozaki, Nakakoma-gun (JP); Yuichi Sakai, Nakakoma-gun (JP); Shigeru Iwaoka, Nakakoma-gun (JP); Nobuhiko Saegusa, Nakakoma-gun (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/953,287

(22) Filed: Sep. 30, 2004

(30) Foreign Application Priority Data
Oct. 2, 2003 (JP) 2003-344027

(51) Int. Cl. G09G 3/28

(52) U.S. Cl. 345/60

(57) ABSTRACT

A display apparatus which sequentially applies a scanning pulse to one row electrode of the row electrode pair while applying a pixel data pulse corresponding to the pixel data to the column electrodes one display line by one display line, simultaneously with the scanning pulse, to selectively produce an address discharge in the second discharge cell in the address period, applies a sustain pulse to the row electrode pairs in the sustain period, and produces a reset discharge in the same discharge current direction as the address discharge between one row electrode of the row electrode pair and the column electrode in the second discharge cell immediately before the address period of at least the first sub-field of the one-field display period, and a method of driving the display panel.

### BACKGROUND OF THE INVENTION

1. Field of the Invention

The present invention relates to a display apparatus equipped with a display panel, and a method for driving a display panel.

2. Description of the Related Art

In recent years, a plasma display apparatus equipped with a surface-discharge AC plasma display panel has drawn attention as a large and thin color display panel (see, for example, Japanese Patent Application Kokai No. 5-205642).

Known as a surface-discharge AC plasma display panel is a panel having pixel cells, which act as respective pixels, each having a selection cell and a display cell (see, for example, Japanese Patent Application Kokai No. 2003-31130 or 2003-086108). The panel has a front substrate and a back substrate opposing each other through a discharge space, a plurality of row electrode pairs disposed on the inner surface of the front substrate, and a plurality of column electrodes arranged on the inner surface of the back substrate to intersect with the row electrode pairs, and is formed with pixel cells at respective intersections of the row electrode pairs and column electrodes, each of which is comprised of a display cell and a selection cell including a light absorption layer close to the substrate and a light absorption layer close to the back substrate. The display cell has one and the other of row electrodes, which form a row electrode pair, opposing within the discharge space, while the selection cell has a column electrode and one row electrode of a row electrode pair opposing in the discharge space. For driving the plasma display panel, there are at least an address period for determining the state of each pixel cell to be lit or unlit, and a sustain period for which a discharge is sustained for lighting. In a selection cell of a pixel cell which should be in a lit state, a discharge (selection discharge) is produced between one of row electrode pair and a column electrode in the address period, and in a display cell of this pixel cell, a discharge is produced between the row electrodes in pairs during the sustain period to maintain the lit state.

As described above, in the cell structure which has a selection cell separated from a display cell, for drawing a selection discharge produced in the selection cell into the display cell to set the display cell in the lit state or unlit state, a pulse at a relatively high voltage must be applied between one of the row electrodes (scanning electrode) and a column electrode. However, depending on a wall charge distribution state within the selection cell immediately before the address period, it is possible to produce an erroneous selection discharge even in a selection cell of a pixel cell which should be set in the unlit state.

### SUMMARY OF THE INVENTION

It is an object of the present invention to provide a display apparatus which employs a plasma display panel that has a cell structure having a selection cell and a display cell separated from each other and which is capable of producing a stable discharge while preventing an erroneous selection discharge in each cell, and a method for driving the display panel.

A display apparatus according to the present invention is an apparatus for displaying an image by dividing a display period of one field into a plurality of sub-fields each having an address period and a sustain period in accordance with pixel data for each pixel based on an input video signal, the display apparatus comprising: a display panel having a front substrate and a back substrate opposing each other through a discharge space, a plurality of row electrode pairs covered with a dielectric layer on an inner surface of the front substrate, and a plurality of column electrodes arranged on an inner surface of the back substrate to intersect with the row electrode pairs, and formed with a unit light emission including a first discharge cell and a second discharge cell having a light absorption layer on the front substrate side area at each intersection of the row electrode pair and the column electrode; an addressing portion which sequentially applies a scanning pulse to one row electrode of each of the row electrode pairs while applies a pixel data pulse corresponding to the pixel data to the column electrodes one display line by one display line, simultaneously with the scanning pulse, to selectively produce an address discharge in the second discharge cell in the address period; a sustaining portion which applies a sustain pulse to the row electrode pairs in the sustain period; and a resetting portion which produces a reset discharge in the same discharge current direction as the address discharge between the one row electrode and the column electrode in the second discharge cell immediately before the address period of at least the first sub-field of the one-field display period.

A method for driving a display panel according to the present invention is a method for driving a display panel having a front substrate and a back substrate opposing each other through a discharge space, a plurality of row electrode pairs covered with a dielectric layer on an inner surface of the front substrate, and a plurality of column electrode arranged on an inner surface of the back substrate to intersect with the row electrode pairs, and formed with a unit light emission including a first discharge cell and a second discharge cell having a light absorption layer on the front substrate side area and a secondary electron emission material layer on the back substrate side at each intersection of the row electrode pair and the column electrode, in accordance with pixel data for each pixel based on an input video signal, the method comprising the steps of: dividing a one-field display period into a plurality of sub-fields each having an address period and a sustain period; sequentially applying a scanning pulse of positive polarity to one row electrode of each of the row electrode pairs while applying a pixel data pulse corresponding to the pixel data to the column electrodes one display line by one display line such that the column electrode side becomes negative, simultaneously with the scanning pulse, to selectively produce an address discharge in the second discharge cell in the address period; applying a sustain pulse to the row electrode pairs in the sustain period; and producing a reset discharge in the same discharge current direction as the address discharge between one row electrode of the row electrode pair and the column electrode in the second discharge cell immediately before the address period of at least the first sub-field of the one-field display period.

### BRIEF DESCRIPTION OF THE DRAWINGS

FIG. 1 is a diagram showing the general configuration of a plasma display apparatus to which the present invention is applied;

FIG. 2 is a plan view of a portion of the structure of a PDP in the apparatus of FIG. 1, viewed from the display plane side;

FIG. 3 is a diagram showing a cross-section of the PDP on a V1-V1 line shown in FIG. 2;

FIG. 4 is a diagram showing a cross-section of the PDP on a V2-V2 line shown in FIG. 2;

FIG. 5 is a diagram showing a cross-section of the PDP on a W1-W1 line shown in FIG. 2;

FIG. 6 is a diagram showing a pixel data conversion table in a selective erasure addressing method, and a light emission driving pattern based on pixel driving data GD generated in accordance with the pixel data conversion table;

FIG. 7 is a diagram showing an exemplary light emission driving sequence in driving based on the selective erasure addressing method; and

FIG. 8 is a diagram showing a variety of driving pulses applied to the PDP during a sub-field SF1 and part of SF2 in the apparatus of FIG. 1, and their application timings.

### DETAILED DESCRIPTION OF THE INVENTION

In the following, one embodiment of the present invention will be described in detail with reference to the drawings.

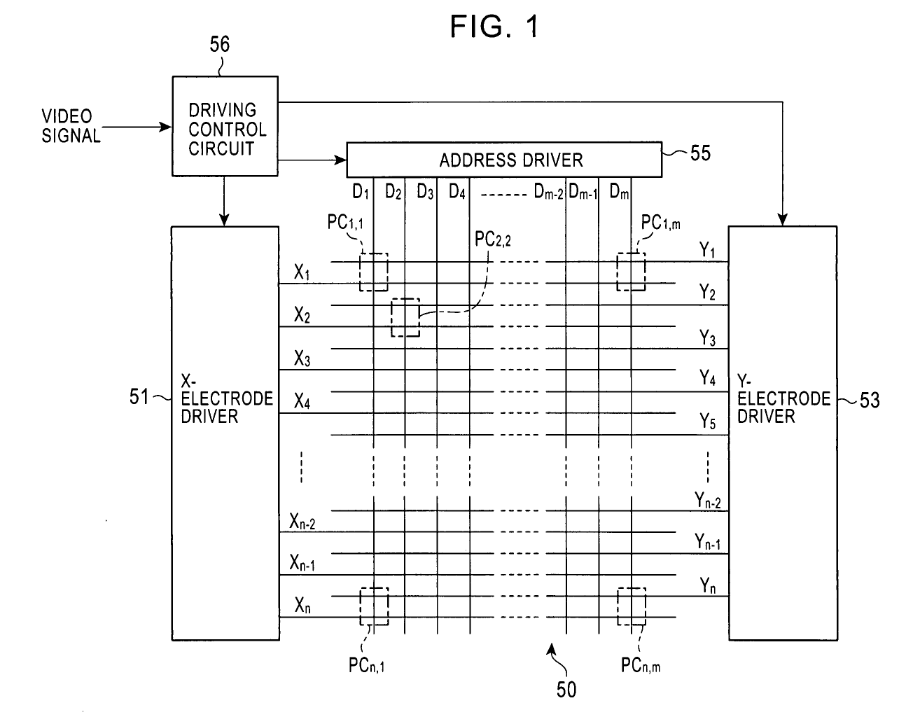

FIG. 1 is a diagram showing the configuration of a plasma display apparatus as a display apparatus according to the present invention.

As shown in FIG. 1, the plasma display apparatus comprises a PDP 50 as a plasma display panel, an X-electrode driver 51, a Y-electrode driver 53, an address driver 55, and a driving control circuit 56.

The PDP 50 is formed with belt-shaped column electrodes D₁-Dₘ which extend respectively in the vertical direction on a display screen. The PDP 50 is also formed with row electrodes X₁-Xₙ and row electrodes Y₁-Yₙ, which extend respectively in the horizontal direction on the display screen, arranged alternately in the order of numbers, as shown in FIG. 1. Pairs of row electrodes, i.e., a row electrode pair (X₁, Y₁)-a row electrode pair (Xₙ, Yₙ) comprise a first display line to an n-th display line, respectively, on the PDP 50. At an intersection of each display line with each of the column electrodes D₁-Dₘ (area surrounded by a one-dot chain line in FIG. 1), a pixel cell (unit light emitting region) PC is formed to comprise a pixel. Specifically, in the PDP 50, pixel cells PC_{1,1}-PC_{1,m} belonging to the first display line, pixel cells PC_{2,1}-PC_{2,m} belonging to the second display line, . . . , pixel cells PC_{n,1}-PC_{n,m} belonging to the n-th display line are arranged in a matrix.

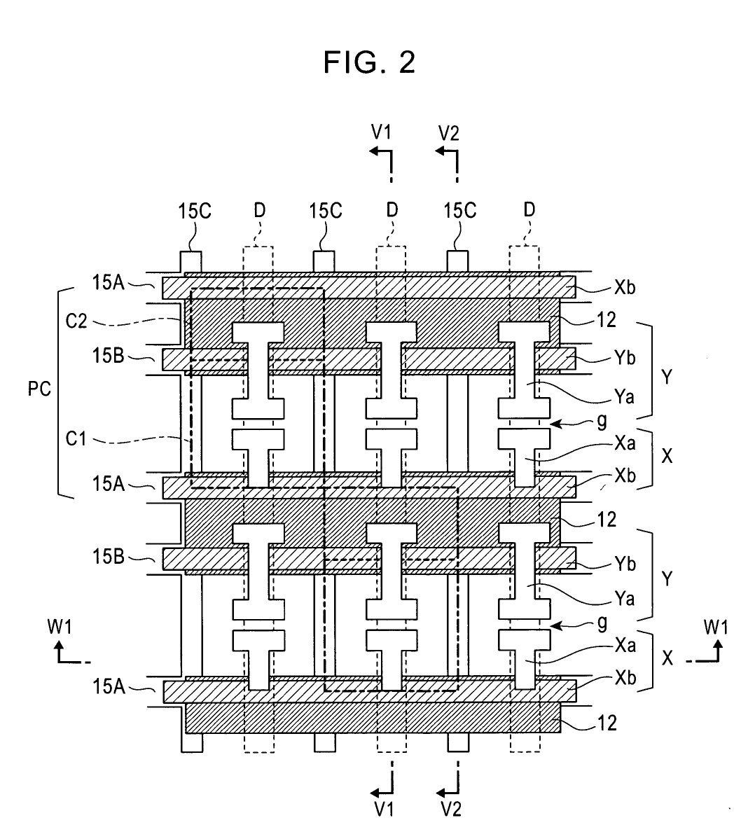

FIGS. 2-5 are diagrams showing extracted portions of the internal structure of the PDP 50.

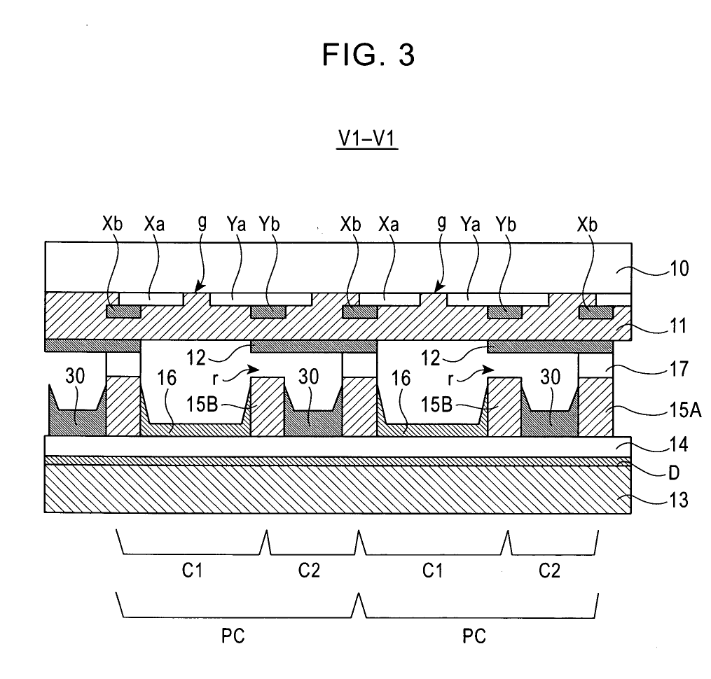

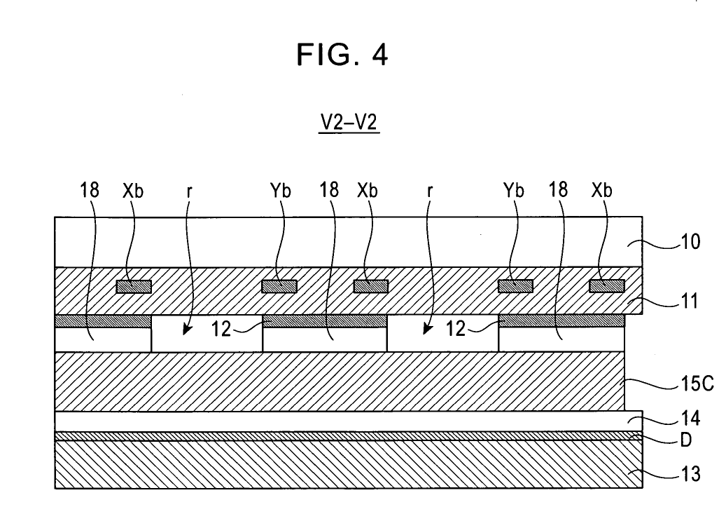

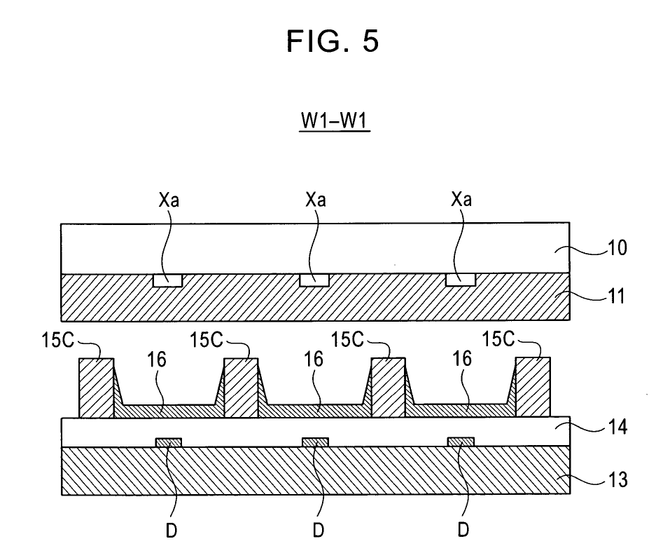

FIG. 2 is a plan view of the PDP 50 taken from the display plane side. FIG. 3 is a cross-sectional view of the PDP 50 taken from a V1-V1 line shown in FIG. 2. FIG. 4 is a cross-sectional view of the PDP taken from a V2-V2 line shown in FIG. 2. FIG. 5 is a cross-sectional view of the PDP 50 taken from a W1-W1 line shown in FIG. 2.

As shown in FIG. 2, the row electrode Y is comprised of a belt-shaped bus electrode Yb (main body of the row electrode Y) extending in the horizontal direction on the display screen, and a plurality of transparent electrodes Ya connected to the bus electrode Yb. The bus electrode Yb is formed, for example, of a black metal film. The transparent electrodes Ya are formed of transparent conductive films such as ITO, and are disposed at positions corresponding to the respective column electrodes D on the bus electrode Yb, respectively. The transparent electrodes Ya extend in a direction perpendicular to the bus electrode Yb, and have their one and other ends made wider as shown in FIG. 2. In other words, the transparent electrode Ya can be regarded as a protrusive electrode protruding from the main body of the row electrode Y. The row electrode X is comprised of a belt-shaped bus electrode Xb (main body of the row electrode) extending in the horizontal direction on the display screen, and a plurality of transparent electrodes Xa connected to the bus electrode Xb. The bus electrode Xb is formed, for example, of a black metal film. The transparent electrodes Xa are formed of transparent films such as ITO, and are disposed at positions corresponding to the respective column electrodes D on the bus electrode Xb, respectively. The transparent electrodes Xa extend in a direction perpendicular to the bus electrode Yb, and have their one and other ends made wider as shown in FIG. 2. In other words, the transparent electrode Xa can be regarded as a protrusive electrode protruding from the main body of the row electrode X. The wider portions of the respective transparent electrodes Xa and Ya are disposed opposite to each other through a discharge gap g of a predetermined width, as shown in FIG. 2. Specifically, the transparent electrodes Xa and Ya as protrusive electrodes protruding from the main bodies of the respective row electrodes X and Y, which form a pair, are disposed opposite to each other through the discharge gap g.

As shown in FIG. 3, the row electrode Y comprised of the transparent electrodes Ya and bus electrode Yb, and the row electrode X comprised of the transparent electrodes Xa and bus electrode Xb are formed on the back surface of the front transparent substrate 10 which comprises the display plane of the PDP 50. Further, a dielectric layer 11 is formed on the back surface of the front transparent substrate 10 to cover these row electrodes X and Y. At a position corresponding to each selection cell C2 (later described) on the surface of the dielectric layer 11, an extended dielectric layer 12 is formed to protrude from the dielectric layer 11 toward the back side. The extended dielectric layer 12 is formed of a belt-shaped light absorption layer including a black or a dark pigment, and is formed to extend in the horizontal direction on the display plane, as shown in FIG. 2. The surfaces of the extended dielectric layers 12 and the surface of the dielectric layer 11 on which the extended dielectric layers 12 are not formed are covered with a protection layer (not shown) formed of MgO (magnesium oxide). On the back substrate 13 arranged in parallel with the front transparent substrate 10, a plurality of column electrodes D, which extend in the direction perpendicular to the bus electrodes Xb and Yb (vertical direction), are arranged in parallel at predetermined intervals. The back substrate 13 is formed with a white column electrode protection layer (dielectric layer) 14 for covering the column electrodes D. A partition 15 comprised of a first lateral wall 15a, a second lateral wall 15B, and a vertical wall 15C is formed on the column electrode protection layer 14. The first lateral wall 15A is formed to extend in the horizontal direction on the display plane at a position on the column electrode protection layer 14 opposing the bus electrode Xb. The second lateral wall 15B is formed to extend in the horizontal direction on the display plane at a position on the column electrode protection layer 14 opposing the bus electrode Yb. The vertical wall 15C is formed to extend in the direction perpendicular to the bus electrode Xb (Yb) at a position between the transparent electrodes Xa (Ya) disposed at regular intervals on the bus electrode Xb (Yb).

Also, as shown in FIG. 3, a secondary electron emission material layer 30 is formed in a region (including a side surface of each of the vertical wall 15C, first lateral wall 15A and second lateral wall 15B) opposing the extended dielectric layer 12 on the column electrode protection layer 14. The secondary electron emission material layer 30 is a layer made of a high γ lateral which has a low work function (for example, 4.2 eV or less), or a high secondary electron emission coefficient. Materials for use as the secondary electron emission material layer 20 are, for example, alkali earth metal oxides such as MgO, CaO, SrO, BaO, alkali metal oxides such as Cs₂O, fluorides such as CaF₂, MgF₂, TiO₂, Y₂O₃, or a material which is improved the secondary electron emission coefficient by crystal defect or doped impurities, a diamond like thin film, a carbon nanotube, and the like. On the other hand, in regions on the column electrode protection layer 14 other than the regions opposing the extended dielectric layers 12 (including a side surface of each of the vertical wall 15C, first lateral wall 15A, and second lateral wall 15B), phosphor layers 16 are formed as shown in FIG. 3. As the phosphor layers 16, there are a red fluorescent layer which emits light in red; a green fluorescent layer which emits light in green; and a blue fluorescent layer which emits light in blue, and the assignment has been determined for each pixel cell PC. Between the secondary electron emission material layers 30 and phosphor layers 16 and dielectric layer 11, there exists a discharge space filled with a discharge gas. The first lateral wall 15A, second lateral wall 15B and vertical wall 15C have heights which do not reach the surface of the extended dielectric layer 12 or dielectric layer 11. Therefore, a gap r, through which a discharge gas can pass, exists between the second lateral wall 15B and extended dielectric layer 12, as shown in FIG. 3. Between the first lateral wall 15A and the extended dielectric layer 12, a dielectric layer 17 is formed to extend in a direction along the first lateral wall 15A to prevent the interference of discharge. Also, between the vertical wall 15C and extended dielectric layer 12, a dielectric layer 18 is intermittently formed in a direction along the vertical wall 15C, as shown in FIG. 4.

Here, an area surrounded by the first lateral wall 15A and vertical wall 15C (area surrounded by a one-dot chain line in FIG. 2) defines the pixel cell PC which comprises a pixel. Further, as shown in FIGS. 2 and 3, the pixel cell PC is divided into a display cell C1 (first discharge cell) and a selection cell C2 (second discharge cell) by the second lateral wall 15B. As shown in FIGS. 2 and 3, the display cell C1 includes a pair of row electrodes X and Y which comprise a display line, and the phosphor layer 16. On the other hand, the selection cell C2 includes a row electrode Y of a pair of row electrodes which comprise the display line, a row electrode X of a pair of row electrodes which comprise a display line upward adjacent to this display line on the display plane, the extended dielectric layer 12, and the secondary electron emission material layer 30. As shown in FIG. 2, in the display cell C1, a wider portion formed at one end of the transparent electrode Xa of the row electrode X and a wider portion formed at one end of the transparent electrode Ya of the row electrode Y are disposed to oppose each other through the discharge gap g. On the other hand, the selection cell C2 includes a wider portion formed at the other end of the transparent electrode Ya, but does not include the transparent electrode.

Also, as shown in FIG. 3, the discharge space of each of the pixel cells adjacent to each other in the vertical direction (in the horizontal direction in FIG. 3) on the display plane is blocked by the first lateral wall 15A and dielectric layer 17. However, the discharge space of each of the display cell C1 and selection cell C2 belonging to the same pixel cell PC connects through a gap r as shown in FIG. 3. Further, the discharge space of each of the selection cells C2 adjacent to each other in the horizontal direction on the display plane is blocked by the extended dielectric layer 12 and dielectric layer 18, as shown in FIG. 4, whereas the discharge spaces of the respective display cells C1 adjacent to each other in the horizontal direction on the display plane connect to each other.

As described above, each of the pixel cells PC_{1,1}-PC_{n,m} formed on the PDP 50 is comprised of the display cell C1 and selection cell C2 which have the discharge spaces connecting to each other.

In accordance with a timing signal supplied from the driving control circuit 56, the X-electrode driver 51 applies a variety of driving pulses to each of the row electrodes X₁, x₂, x₃, x₄, X₅, . . . Xₙ₋₁ and Xₙ of the PDP 50. In accordance with a timing signal supplied from the driving control circuit 56, the electrode driver 53 applies a variety of driving pulses to each of the row electrodes Y₁, Y₂, Y₃, Y₄, Y₅, . . . , Yₙ₋₁ and Yₙ of the PDP 50. The address driver 55 applies a pixel data pulse to the column electrodes D₁-Dₘ of the PDP 50 in accordance with a timing signal supplied from the driving control circuit 56.

The driving control circuit 56 first converts an input video signal to pixel data of, for example, eight bits, representative of a luminance level for each pixel, and performs error diffusion processing and dither processing on the pixel data. For example, in the error diffusion processing, first, the upper six bits of the pixel data are defined to be display data, and the remaining lower two bits are defined to be error data. Then, respective error data of the pixel data corresponding to the respective surrounding pixels are weighted and added, and the resulting data is reflected to the display data. With this operation, the luminance of the lower two bits in the original pixel is virtually represented by the surrounding pixels, and therefore, a luminance gradation representation equivalent to 8-bit pixel data can be achieved by 6-bit display data smaller than eight bits. Then, the 6-bit error diffusion processed image data, generated by the error diffusion processing, is subjected to the dither processing. In the dither processing, a plurality of pixels adjacent to each other are grouped into one pixel unit, and the error diffusion processed pixel data corresponding to the respective pixels in the pixel unit are assigned dither coefficients different from one another, and added to generate dither addition pixel data. According to the addition of the dither coefficient, when viewed in one pixel unit, even the upper four bits of the dither addition pixel data can represent the luminance comparable to eight bits.

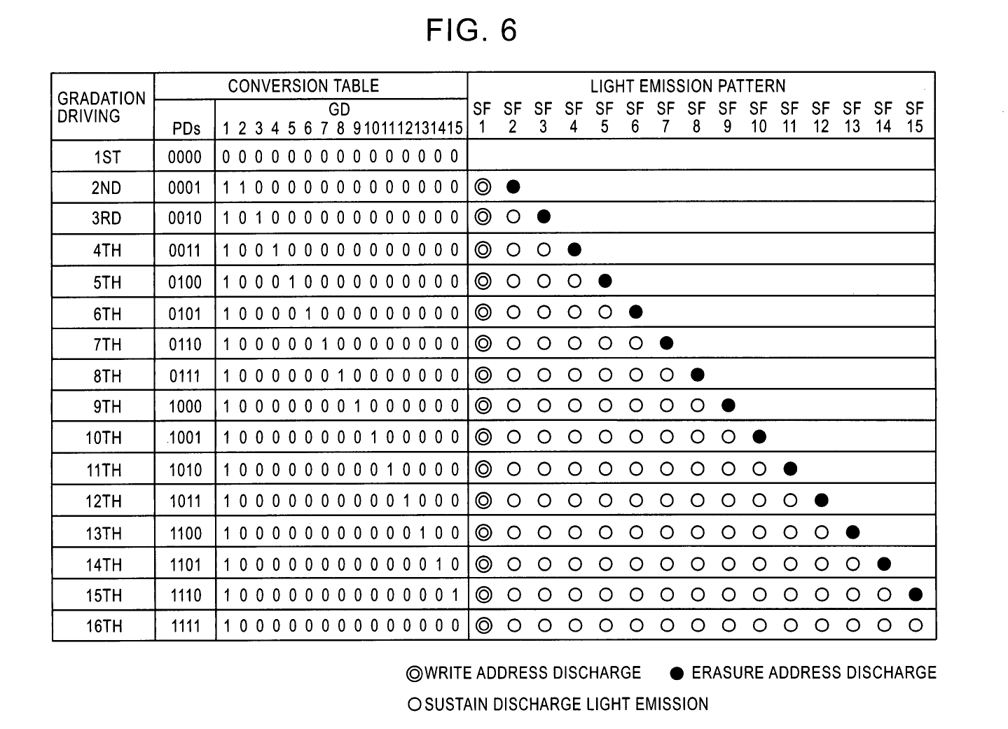

The driving control circuit 56 converts the 8-bit pixel data to 4-bit multi-gradation pixel data PD_{S} by these error diffusion processing and dither processing, and again converts the multi-gradation pixel data PD_{S} to 15-bit pixel driving data GD in accordance with a data conversion table as shown in FIG. 6. Thus, pixel data which can express 256 levels of gradation by eight bits is converted to 15-bit pixel driving data GD comprised a total of 16 patterns. Next, the driving control circuit 56 separates these pixel driving data GD_{1,1}-GD_{n,m} into respective bit digits for each screen of pixel driving data GD_{1,1}-GD_{n,m} to generate pixel driving data bit groups DB1-DB15. The driving control circuit 56 supplies the address driver 55 with one display line (m) of data bits in the pixel driving data bit group DB corresponding to each of sub-fields SF1-SF15.

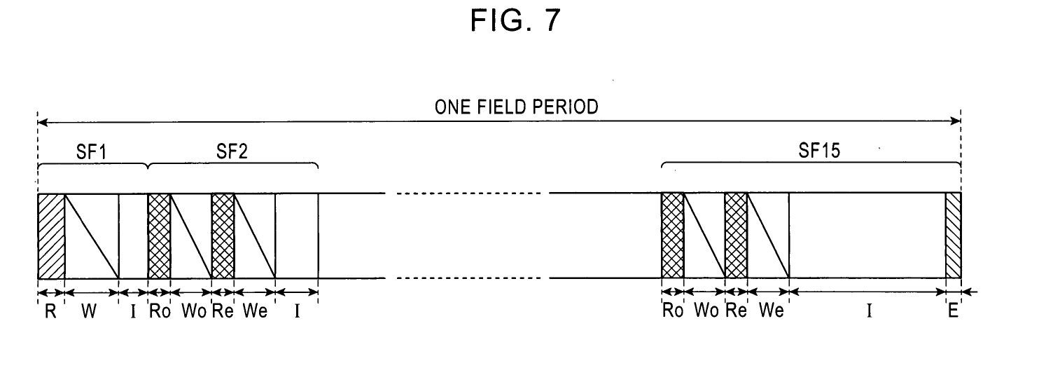

FIG. 7 is a diagram showing a light emission driving sequence, to which the selective erasure addressing method is applied, for driving the PDP 50 to provide a halftone display.

In the light emission driving sequence shown in FIG. 7, each field in a video signal is divided into 15 sub-fields SF1-SF15. In the first sub-field SF1, a reset stage R, a selective write address stage W, and a light emission sustain stage I are executed in this order. In the second sub-field SF2 to fifteenth sub-field SF15, a reset stage Ro, a selective erasure address stage Wo, a reset stage Re, a selective erasure address stage We, and a light emission sustain stage I are executed in this order. In the fifteenth sub-field SF15, an erasure stage E is executed immediately after the light emission sustain stage I.

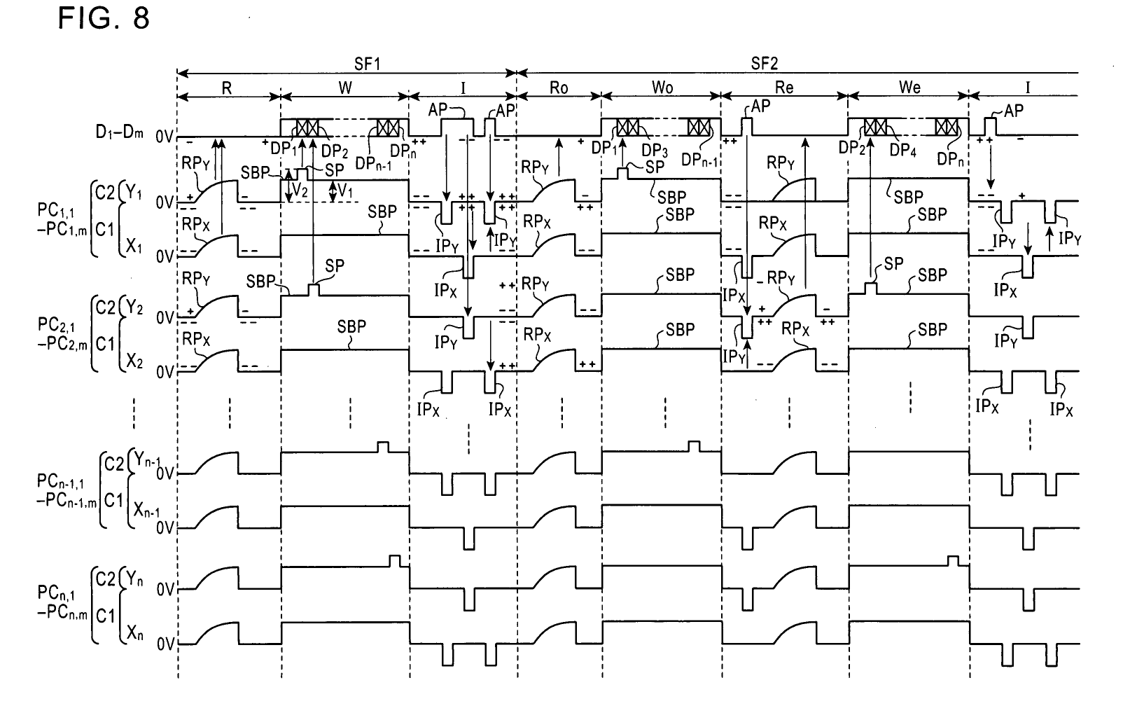

FIG. 8 is a diagram showing a variety of driving pulses which are applied to the PDP 50 by each of the address driver 5.5, X-electrode driver 51, and Y-electrode driver 53 in each stage in accordance with the light emission driving sequence shown in FIG. 7. In FIG. 8, the first sub-field SF1 and part of the next sub-field SF2 are only extracted for illustration. Also, in FIG. 8, discharge current directions between electrodes are indicated by arrows.

First, as a wall charge distribution state immediately before the reset stage R of the first sub-field SF1, a negative charge − is present on the column electrodes D (D₁-Dₙ) in the selection cell C2; a positive charge + is present on the row electrodes Y (Y₁-Yₙ); a negative charge −− is present on the row electrode Y in the display cell C1; and a negative charge −− is present on the row electrode X (X₁-Xₙ). Here, +, −, ++, and −− indicate not only the polarity of a wall charge but also the amount of the wall charge. In other words, ++, and −− indicate a larger amount of wall discharge than +, and −.

In the reset stage R of the first sub-field SF1, the Y-electrode driver 53 generates a reset pulse RP_{Y} of positive polarity which slowly changes in rising, and simultaneously applies the reset pulse RP_{Y} to each of the row electrodes Y₁-Yₙ of the PDP 50. Also, at the same timing as the reset pulse RP_{Y}, the X-electrode driver 51 generates a reset pulse RP_{X} of positive polarity which is simultaneously applied to each of the row electrodes X₁-Xₙ of the PDP 50. In response to the application of these reset pulses RP_{Y} and RP_{X}, a subtle reset discharge is produced between the column electrode D and row electrode Y in the selection cell C2 of each of all pixel cells PC of the PDP 50 to form a wall charge in the selection cell C2. After the end of the reset discharge, a wall charge + of positive polarity is formed on the column electrode D in the selection cell C2, while a wall charge − of negative polarity is formed on the row electrode Y. Also, a wall charge −− of negative polarity is formed on the row electrode Y in the display cell C1, and a wall charge −− of negative polarity is also formed on the row electrode X.

As described above, in the reset stage R, the wall charge is formed in the selection cell C2 of all the pixel cells PC of the PDP 50.

Next, in the selective write address stage W of the first sub-field SF1, the Y-electrode driver 53 applies a scanning base pulse SBP having a voltage V1 of positive polarity to all the row electrodes Y₁-Yₙ, and also sequentially applies a scanning pulse SP having a voltage V2 (V2>V1) of positive polarity in a waveform protruding from the scanning base pulse SBP to each of the row electrodes Y₁-Yₙ. In the meantime, the X-electrode driver 51 applies V1 to each of the row electrodes X₁-Xₙ. The address driver 55 converts each data bit in the pixel driving data bit group DB1 corresponding to the sub-field SF1 to a pixel data pulse DP having a pulse voltage in accordance with its logical level. For example, the address driver 55 converts a pixel driving data bit at logical level 0 to a high-voltage pixel data pulse DP, while it converts a pixel driving data bit at logical level 1 to a low voltage (0 volt) pixel data pulse DP. Then, these pixel data pulses DP are applied to the column electrodes D₁-Dₘ for one display line (m) in synchronism with the application timing of the scanning pulse SP. Specifically, the address driver 55 first applies the column electrodes D₁-Dₘ with a pixel data pulse group DP₁ comprised of m pixel data pulses DP corresponding to the first display line, and next applies the column electrodes D₁-Dₘ with a pixel data pulse group DP₂ comprised of m pixel data pulse DP corresponding to the second display line. A selective write address discharge is produced between the column electrode D and row electrode Y in the selection cell C2 of the pixel cell PC which was simultaneously applied with the scanning pulse SP having the voltage V2 of positive polarity and the low-voltage (0 volt) pixel data pulse DP.

The selective address discharge in the selection cell C2 is a discharge necessary for setting the display cell C1 to one of a lit cell state or an unlit cell state by extending into the display cell C1 through the gap r.

After the selective write address discharge, a wall charge ++ of positive polarity is formed on the column electrode D in the selection cell C2 of the pixel cell PC which should be lit, and a wall charge −− of negative polarity is formed on the row electrode Y. Also, a wall charge −− of negative polarity is formed on the row electrode Y in the display cell C1, and a wall charge −− of negative polarity is also formed on the row electrode X.

On the other hand, since the pixel cell PC, which should be unlit, has not been applied with the pixel data pulse DP, no selective write address discharge is produced. Therefore, the wall charge distribution state in the pixel cell PC remains the same from immediately after the end of the reset discharge.

Next, in the sustain stage I of the first sub-field SF1, the Y-electrode driver 53 repeatedly applies a sustain pulse IP_{Y} of negative polarity to each of the row electrodes Y₁-Yₙ, while the X-electrode driver 51 repeatedly applies a sustain pulse IP_{X} of negative polarity to each of the row electrodes X₁-Xₙ. The application of the sustain pulses is alternately performed with the row electrodes Y₁-Yₙ and row electrodes X₁-Xₙ, wherein the application is repeated a number of times assigned to the sub-field to which this sustain stage I belongs. The address driver 55 applies the column electrodes D₁-Dₘ with an address pulse AP of positive polarity in synchronism with the sustain pulse IP_{Y} first applied to each of the row electrodes Y. While the sustain pulse AP has a width from the time the sustain pulse IP_{Y} is generated to the time the next sustain pulse IP_{X} is extinct, the width of the sustain pulse AP is equal to the width of the sustain pulse IP_{Y} when the sustain stage I ends with the sustain pulse IP_{Y}.

In the pixel cell PC which should be lit (lit cell), as the first sustain pulse IP_{Y} and the address pulse AP, in synchronism therewith, are applied, a discharge is produced between the column electrode D and row electrode Y in the selection cell C2. The discharge caused by the sustain pulse and address pulse AP results in the formation of a wall charge −− of negative polarity on the column electrode D in the selection cell C2, and the formation of a wall charge ++ of positive polarity on the row electrode Y. The wall charge on the row electrode Y inverts in polarity. Also, a wall charge ++ of positive polarity is formed on the row electrode Y in the display cell C1, and a wall charge −− of negative polarity is also formed on the row electrode X.

The formation of the wall charge causes the display cell C1 to be set in the lit cell state, and a sustain discharge (display discharge) occurs between the row electrode Y and row electrode X in the display cell C1 upon application of the next sustain pulse IP_{X}.

In the pixel cell PC which should be unlit (unlit cell), a wall charge − of negative polarity is formed on the row electrode Y in the selection cell C2, and a wall charge + of positive polarity is formed on the column electrode D, so that no discharge occurs between the column electrode D and row electrode Y in the selection cell C2 upon application of the first sustain pulse IP_{Y} and the address pulse AP in synchronism therewith, and the wall charge does not either invert in polarity. Therefore, at the time the next sustain pulse IP_{X} is applied, no sustain discharge occurs between the row electrode Y and row electrode X in the display cell C1.

In a lit cell, the last sustain pulse IP_{Y} in the sustain stage I is applied to the row electrode Y, and the address pulse AP is applied to the column electrode D in synchronism with the sustain pulse IP_{Y}, thereby causing a discharge between the column electrode D and row electrode Y in the selection cell C2 to form a wall charge −− of negative polarity on the column electrode D of the selection cell C2, and to form a wall charge ++ of positive polarity on the row electrode Y. In the display cell C1, a discharge occurs between the row electrode X and row electrode Y to form a wall charge ++ of positive polarity on the row electrode Y and to form a wall charge −− of negative polarity on the row electrode X.

In the reset stage Ro of the second sub-field SF2, the Y-electrode driver 53 generates a reset pulse RP_{Y} of positive polarity which slowly changes in rising, and simultaneously applies the reset pulse RP_{Y} to each of the row electrodes Y₁, Y₂-Yₙ of the PDP 50. Also, at the same timing as the reset pulse RP_{Y}, the X-electrode driver 51 generates a reset pulse RP_{X} of positive polarity which is simultaneously applied to each of the row electrodes X₁, X₂-Xₙ of the PDP 50.

In pixel cells in odd-numbered rows of all the pixel cells PC of the PDP 50 in which the sustain discharge has been produced in the sustain stage I of the first sub-field SF1, in response to the application of these reset pulses RP_{Y} and RP_{X}, a subtle opposite reset discharge is produced between the column electrode D and row electrode Y in the selection cell C2 of each of all pixel cells PC of the PDP 50 to form a wall charge in the selection cell C2. After the end of the reset discharge, a wall charge + of positive polarity is formed on the column electrode D in the selection cell C2, while a wall charge − of negative polarity is formed on the row electrode Y. Also, a wall charge ++ of positive polarity is maintained on the row electrode Y in the display cell C1, and a wall charge −− of negative polarity is also maintained on the row electrode X. In this reset stage Ro, no discharge occurs in the pixel cells in the even-numbered rows in response to the application of the reset pulse RP_{X}.

In the next address stage Wo of the second sub-field SF2, the Y-electrode driver 53 applies the row electrodes Y₁, Y₂-Yₙ with a scanning base pulse SBP having a voltage V1 of positive polarity, and sequentially applies each of the odd-numbered row electrodes Y₁, Y₃-Yₙ₋₁ with a scanning pulse SP having a voltage V2 of positive polarity in a waveform protruding from the scanning base pulse SBP. The X-electrode driver 51 simultaneously applies each of the row electrodes X₁, X₂-Xₙ with the scanning base pulse SBP having the voltage V1 of positive polarity. The application of the scanning base pulse SBP by the Y-electrode driver 53 is performed simultaneously with the application of the scanning base pulse SBP by the X-electrode driver 51. The address driver 55 converts each of data bits in the pixel driving data bits DB2 corresponding to the sub-field SF2 to a pixel data pulse having a pulse voltage corresponding to its logical level. For example, the address driver 55 converts a pixel driving data bit at logical level 0 to a low-voltage (0 volt) pixel data pulse DP, while it converts a pixel driving data bit at logical level 1 to a pixel data pulse DP having a high voltage of positive polarity. This conversion is reverse in logic to the first sub-field. Then, these pixel data pulses DP are applied to the column electrodes D₁-Dₘ for one display line (m) in synchronism with the application timing of the scanning pulse SP. Specifically, the address driver 55 first applies the column electrodes D₁-Dₘ with a pixel data pulse group DP₁ comprised of m pixel data pulses DP corresponding to the first display line, and next applies the column electrodes D₁-Dₘ with a pixel data pulse group DP₂ comprised of m pixel data pulse DP corresponding to the second display line. A selective write address discharge is produced between the column electrode D and row electrode Y in the selection cell C2 of the pixel cell PC which was simultaneously applied with the scanning pulse SP having the voltage V2 of positive polarity and the low-voltage (O volt) pixel data pulse DP.

After the selective write address discharge, a wall charge + of positive polarity is formed on the column electrode D in the selection cell C2 of the pixel cells PC which should be unlit on the odd-numbered rows, and a wall charge − of negative polarity is formed on the row electrode Y. Also, a wall charge −− of negative polarity is formed on the row electrode Y in the display cell C1 of the pixel cells PC on the odd-numbered rows, and the wall charge −− of negative polarity is also formed on the row electrode X. Thus, the pixel cell PC, which should be unlit, is set to an unlit state.

On the other hand, since the pixel cell PC, which should be lit, has not been applied with the pixel data pulse DP, no selective write address discharge is produced. Therefore, the wall charge distribution state in the pixel cell PC remains the same from immediately after the end of the reset discharge in the reset stage Ro. Specifically, the wall charge ++ of positive polarity is maintained on the row electrode Y in the display cell C1, and the wall charge −− of negative polarity is maintained on the row electrode.

In the reset stage Re of the second sub-field SF2, the Y-electrode driver 53 applies a sustain pulse IP_{Y} of negative polarity to each of the even-numbered row electrodes Y₂, Y₄-Yₙ, of the PDP 50, and simultaneously, the X-electrode driver 51 applies a sustain pulse IP_{X} of negative polarity to each of the odd-numbered row electrodes X₁, X₃-Xₙ₋₁. The address driver 55 applies an address pulse AP of positive polarity to the column electrodes D₁-Dₘ in synchronism with the application of the sustain pulses IP_{Y}, IP_{X}. As a result, no discharge occurs in the pixel cell PC which has been set to an unlit cell in the first sub-field SF1 to maintain the unlit state. In the pixel cell PC which has been set to a lit cell in the first sub-field SF1, a discharge occurs in each of the selection cell C2 and display cell C1 in the even-numbered rows, a wall charge + of positive polarity is formed on the row electrode Y in the selection cell C2, a wall charge − of negative polarity is formed on the column electrode D, a wall charge ++ of positive polarity is formed on the row electrode Y of the display cell C1, and a wall charge −− of negative polarity is formed on the row electrode X.

Subsequently, the Y-electrode driver 53 generates a reset pulse RP_{Y} of positive polarity which slowly changes in rising, and simultaneously applies the reset pulse RP_{Y} to each of the row electrodes Y₁ Y₂-Yₙ of the PDP 50. Also, at the same timing as the reset pulse RP_{Y}, the X-electrode driver 51 generates a reset pulse RP_{X} of positive polarity which is simultaneously applied to each of the row electrodes X₁, X₂-Xₙ of the PDP 50.

In pixel cells in the even-numbered rows of all the pixel cells PC of the PDP 50 in which the sustain discharge has been produced in the sustain stage I of the first sub-field SF1, a subtle opposite reset discharge is produced between the column electrode D and row electrode Y in the selection cell C2, in response to the application of these reset pulses RP_{Y} and RP_{X}, to form a wall charge in the selection cell C2. After the end of the reset discharge, a wall charge + of positive polarity is formed on the column electrode D in the selection cell C2, while a wall charge − of negative polarity is formed on the row electrode Y. Also, a wall charge ++ of positive polarity is maintained on the row electrode Y in the display cell C1 of the even-numbered pixel cells, and a wall charge −− of negative polarity is also maintained on the row electrode X. In this reset stage Re, no discharge occurs in the pixel cells in the odd-numbered rows in response to the application of the reset pulse RP_{X}.

In the next address stage We of the second sub-field SF2, the Y-electrode driver 53 applies the row electrodes Y₁, Y₂-Yₙ with a scanning base pulse SBP having a voltage V1 of positive polarity, and sequentially applies each of the even-numbered row electrodes Y₂. Y₄-Yₙ with a scanning pulse SP having a voltage V2 of positive polarity in a waveform protruding from the scanning base pulse SBP. The X-electrode driver 51 simultaneously applies each of the row electrodes X₁, X₂-Xₙ with the scanning base pulse SBP having the voltage V1 of positive polarity. The application of the scanning base pulse SBP by the Y-electrode driver 53 is performed simultaneously with the application of the scanning base pulse SBP by the X-electrode driver 51. As is the case with the address stage Wo, the address driver 55 converts each of data bits in the pixel driving data bits DB2 corresponding to the sub-field SF2 to a pixel data pulse having a pulse voltage corresponding to its logical level. Then, these pixel data pulses DP are applied to the column electrodes D₁-Dₘ for one display line (m) in synchronism with the application timing of the scanning pulse SP. Specifically, the address driver 55 first applies the column electrodes D₁-Dₘ with a pixel data pulse group DP₁ comprised of m pixel data pulses DP corresponding to the first display line, and next applies the column electrodes D₁-Dₘ with a pixel data pulse group DP₂ comprised of m pixel data pulse DP corresponding to the second display line. A selective write address discharge is produced between the column electrode D and row electrode Y in the selection cell C2 of the pixel cell PC which was simultaneously applied with the scanning pulse SP having the voltage V2 of positive polarity and the low-voltage (0 volt) pixel data pulse DP.

After the selective write address discharge, a wall charge + of positive polarity is formed on the column electrode D in the selection cell C2 of the pixel cell PC which should be unlit on the even-numbered rows, and a wall charge − of negative polarity is formed on the row electrode Y. Also, a wall charge −− of negative polarity is formed on the row electrode Y in the display cell C1 of the pixel cells PC on the even-numbered rows, and the wall charge −− of negative polarity is also formed on the row electrode X. Thus, the pixel cell PC, which should be unlit, is set to an unlit state.

On the other hand, since the pixel cell PC, which should be lit, on the even-numbered rows has not been applied with the pixel data pulse DP, no selective write address discharge is produced. Therefore, the wall charge distribution state in the pixel cell PC remains the same from immediately after the end of the reset discharge in the rest stage Ro. Specifically, the wall charge ++ of positive polarity is maintained on the row electrode Y in the display cell C1, and the wall charge −− of negative polarity is maintained on the row electrode.

Next, in the sustain stage I of the second sub-field SF2, the Y-electrode driver 53 repeatedly applies a sustain pulse IP_{Y} of negative polarity to each of the row electrodes Y₁-Yₙ, while the X-electrode driver 51 repeatedly applies a sustain pulse IP_{X} of negative polarity to each of the row electrodes X₁-Xₙ. The application of the sustain pulses is alternately performed with the row electrodes Y₁-Yₙ and row electrodes X₁-Xₙ, wherein the application is repeated a number of times assigned to the sub-field to which this sustain stage I belongs. The address driver 55 applies the column electrodes D₁-Dₘ with an address pulse AP of positive polarity immediately before the first applied sustain pulse IP_{Y}.

Only in the pixel cell PC which should be unlit (in which the selective erasure discharge has occurred, or an unlit cell), as the address pulse AP is applied, a weak discharge is produced between the column electrode D and row electrode Y within the selection cell C2. After the weak discharge has finished in the selection cell C2, a wall charge − of negative polarity is formed on the column electrode D in the selection cell C2, a wall charge + of positive polarity is formed on the row electrode Y in the selection cell C2, to bring an unlit state (neutral state) in the selection cell C2. Here, the wall charges on the column electrode and row electrode Y in the selection cell C2 invert only in polarity.

On the other hand, in the pixel cell which should be lit (in which no selective erasure discharge has not occurred, or a lit cell), the wall charge distribution state in the selection cell C2 remains the same from the end of the reset discharge in the reset stages Ro, Re.

Here, a wall charge −− of negative polarity is formed on the row electrode Y in the display cell C1 which is set to an unlit cell, and a wall charge −− of negative polarity is formed on the row electrode X. Also, a wall charge ++ of positive polarity is formed on the row electrode Y in the display cell C1 which is set to a lit cell, and a wall charge −− of negative polarity is formed on the row electrode X. Therefore, only in the lit cell, a sustain discharge (display discharge) occurs between the row electrode Y and row electrode X in the display cell C1 by the sustain pulse IP_{X} applied the second time.

In a lit cell, the last sustain pulse IP_{Y} in the sustain stage I is applied to the row electrode Y, and the address pulse AP (not shown) is applied to the column electrode D in synchronism with the sustain pulse IP_{Y}, thereby causing a discharge between the column electrode D and row electrode Y in the selection cell C2 to form a wall charge − of negative polarity on the column electrode D of the selection cell C2, and to form a wall charge + of positive polarity on the row electrode Y. In the display cell C1, a discharge occurs between the row electrode X and row electrode Y to form a wall charge ++ of positive polarity on the row electrode Y and to form a wall charge −− of negative polarity on the row electrode X.

The operation of each stage in each of the subsequent third sub-field SF3-fifteenth sub-field SF15 is similar to the operation of each stage in the second sub-field SF2 described above.

In the foregoing embodiment, the column electrode side is made relatively negative to produce a reset discharge and selection discharge, and the sustain pulses of negative polarity are alternately applied. Alternatively, the polarity may be inverted, with the column electrode side made relatively positive to produce a reset discharge and a selection discharge, and the sustain pulses of positive polarity may be alternately applied.

Also, in the foregoing embodiment, the Y-electrodes and X-electrodes are alternately arranged to form a Y-X, Y-X electrode layout, and for reducing reactive power, the pulses applied to the even-numbered Y-electrodes and odd-numbered X-electrodes are made in phase, the pulses applied to the even-numbered X-electrodes and odd-numbered -electrodes are made in phase, and the reset and address stages of the odd-numbered lines and even-numbered lines are temporally separated in a sub-field of selective erasure address. Alternatively, the cell structure may be such that the electrode layout is X-Y, Y-X, and the selection cell C2 in the odd-numbered line is disposed adjacent to the selection cell in the even-numbered line. In this structure, since the pulses applied to the Y-electrodes can be made in phase, and the pulses applied to the X-electrodes can be made in phase, the reset and address stages of the odd-numbered lines and even-numbered lines need not be temporally separated in the sub-field of selective erasure address.

Further, the field, referred to in the foregoing embodiment, takes into consideration an interlaced video signal of the NTSC standard or the like, and corresponds to a frame (screen) in a non-interlaced video signal.

As described above, according to the present invention, since the display apparatus comprises addressing means for sequentially applying a scanning pulse to one row electrode of the row electrode pair while applying a pixel data pulse corresponding to the pixel data to the column electrodes one display line by one display line, simultaneously with the scanning pulse, to selectively produce an address discharge in the second discharge cell in the address period, sustaining means for applying a sustain pulse to the row electrode pairs in the sustain period, and resetting means for producing a reset discharge in the same discharge current direction as the address discharge between one row electrode of the row electrode pair and the column electrode in the second discharge cell immediately before the address period of at least the first sub-field of the one-field display period, a stable discharge can be produced while preventing an erroneous selection discharge of each cell, using a display panel which has a cell structure in which a selection cell is separated from a display cell.

This application is based on a Japanese Application No. 2003-344027 which is hereby incorporated by reference.

1. A display apparatus for displaying an image by dividing a display period of one field into a plurality of sub-fields each having an address period and a sustain period in accordance with pixel data for each pixel based on an input video signal, said display apparatus comprising:
a display panel having a front substrate and a back substrate opposing each other through a discharge space, a plurality of row electrode pairs covered with a dielectric layer on an inner surface of said front substrate, and a plurality of column electrodes arranged on an inner surface of said back substrate to intersect with said row electrode pairs, and formed with a unit light emission including a first discharge cell and a second discharge cell having a light absorption layer on the front substrate side area at each intersection of said row electrode pair and said column electrode;
an addressing portion which sequentially applies a scanning pulse to one row electrode of each of said row electrode pairs while applies a pixel data pulse corresponding to the pixel data to said column electrodes one display line by one display line, simultaneously with the scanning pulse, to selectively produce an address discharge in said second discharge cell in the address period;
a sustaining portion which applies a sustain pulse to said row electrode pairs in said sustain period; and
a resetting portion which produces a reset discharge in the same discharge current direction as the address discharge between the one row electrode and said column electrode in said second discharge cell immediately before the address period of at least the first sub-field of the one-field display period.

2. A display apparatus according to claim 1, further comprising:
a secondary electron discharge material layer on a back substrate side of said second discharge cell, wherein:
said resetting portion applies a reset pulse between one row electrode of said row electrode pair and said column electrode such that the column electrode side becomes relatively negative to produce the reset discharge in said second discharge cell,
said addressing portion applies the scanning pulse and the pixel data pulse such that the column electrode side becomes relatively negative; and
said sustaining portion applies the sustain pulse of negative polarity in the sustain period.

3. A display apparatus according to claim 1, wherein said addressing portion extends a selective address discharge in said second discharge cell into said first discharge cell to set said first discharge cell to one of a lit cell state and an unlit cell state.

4. A display apparatus according to claim 1, wherein:
said first discharge cell includes a portion in which said one row electrode and the other row electrode making up said row electrode pair oppose through a first discharge gap in the discharge space, and
said second discharge cell includes a portion in which said column electrode and the one row electrode oppose through a second discharge gap in the discharge space.

5. A display apparatus according to claim 1, wherein:
said one row electrode and other row electrode making up said row electrode pair each includes a main body extending in a row direction, and a protrusion which protrudes in a column direction from said main body through a first discharge gap for each unit light emission area, and
said first discharge cell includes a portion which opposes said protrusion through the first discharge gap in the discharge space, and said second discharge cell includes a portion in which said column electrode and said body in said one row electrode oppose through a second discharge gap in the discharge space.

6. A display apparatus according to claim 1, wherein:
said display panel comprises a divisional wall including a vertical wall for sectioning the discharge space of an adjacent unit light emission area in a row direction, and a horizontal wall for sectioning in a column direction, and a partition for sectioning the discharge space of said first discharge cell and the discharge space of said second discharge cell in the unit light emission area, and
the discharge space of the second discharge cell of each unit light emission area and the discharge space of the adjacent unit light emission area are closed by said divisional wall, the discharge space of the first discharge cell of each unit light emission area is connected to the discharge space of the first discharge cell of the adjacent unit light emission area in the row direction, and the discharge space of said first discharge cell is connected to the discharge space of the second discharge cell in each unit light emission area.

7. A display apparatus according to claim 1, further comprising a phosphor layer formed only in said first discharge cell to emit light only by a discharge.

8. A display apparatus according to claim 1, wherein the reset pulse has a waveform which slowly changes in level in a rising section or a falling section in comparison with the sustain pulse.

9. A display apparatus according to claim 1, wherein:
said addressing portion selectively produces a write address discharge to set a discharge cell to a lit cell state in an address period of each sub-field belonging to continuous sub-fields including the first sub-field of the one-field display period, and
selectively produces an erasure address discharge to set a discharge cell to an unlit cell state in the address period of each sub-field subsequent to the first sub-fields.

10. A display apparatus according to claim 1, wherein said addressing portion applies an address pulse of opposite polarity to said column electrode at the same timing as a first sustain pulse applied to said one row electrode forming part of said row electrode pair in the sustain period to produce a discharge in said first discharge cell.

11. A driving method for driving a display panel having a front substrate and a back substrate opposing each other through a discharge space, a plurality of row electrode pairs covered with a dielectric layer on an inner surface of said front substrate, and a plurality of column electrode arranged on an inner surface of said back substrate to intersect with said row electrode pairs, and formed with a unit light emission including a first discharge cell and a second discharge cell having a light absorption layer on the front substrate side area and a secondary electron emission material layer on the back substrate side at each intersection of said row electrode pair and said column electrode, in accordance with pixel data for each pixel based on an input video signal, said method comprising the steps of:
dividing a one-field display period into a plurality of sub-fields each having an address period and a sustain period;
sequentially applying a scanning pulse of positive polarity to one row electrode of each of said row electrode pairs while applying a pixel data pulse corresponding to the pixel data to said column electrodes one display line by one display line such that the column electrode side becomes negative, simultaneously with said scanning pulse, to selectively produce an address discharge in said second discharge cell in said address period;
applying a sustain pulse to said row electrode pairs in said sustain period; and
producing a reset discharge in the same discharge current direction as said address discharge between one row electrode of said row electrode pair and said column electrode in said second discharge cell immediately before the address period of at least the first sub-field of said one-field display period.
